(19) United States
(12) Patent Application Publication
(10) Pub. No.: US 2026/0336707 A1
(43) Pub. Date: Oct. 29, 2026

(54) VEHICLE REAR SKELETON STRUCTURE

(71) Applicant: TOYOTA JIDOSHA KABUSHIKI KAISHA, Toyota-shi (JP)

(72) Inventors: Norihiro MURASHIGE, Nisshin-shi (JP); Takehiro Ito, Nisshin-shi (JP); Tetsuo Nuruki, Toyota-shi (JP)

(73) Assignee: TOYOTA JIDOSHA KABUSHIKI KAISHA, Toyota-shi (JP)

(21) Appl. No.: 19/547,878

(22) Filed: Feb. 24, 2026

(30) Foreign Application Priority Data
Apr. 24, 2025 (JP) 2025-072736

(51) Int. Cl. B62D 21/15; B62D 25/16

(52) U.S. Cl. CPC B62D 21/152; B62D 25/16

(57) ABSTRACT

The vehicle rear skeleton structure is integrally formed by casting, and includes a rear skeleton body portion including a wheel house portion and a rear side member portion extending from a vehicle rear lower portion of the wheel house portion to the vehicle rear, and a reinforcing portion integrally formed with the rear skeleton body portion and provided at an upper portion of the rear side member portion on a vehicle rear side of the wheel house portion.

### CROSS-REFERENCE TO RELATED APPLICATION

This application claims priority to Japanese Patent Application No. 2025-072736 filed on Apr. 24, 2025. The disclosure of the above-identified application, including the specification, drawings, and claims, is incorporated by reference herein in its entirety.

### BACKGROUND

### 1. Technical Field

The present disclosure relates to a vehicle rear skeleton structure.

### 2. Description of Related Art

Japanese Unexamined Patent Application Publication No. 2024-117583 (JP 2024-117583 A) discloses a vehicle rear skeleton structure including a pair of right and left wheel houses and integrally molded by casting.

### SUMMARY

In the vehicle rear skeleton structure described above, when a side member portion is not appropriately axially compressed and rises at the time of a collision, a wheel house portion rises, and therefore there is room for improvement in the rigidity of the entire vehicle rear skeleton structure.

The present disclosure has been made in view of the above circumstances, and an object of the present disclosure is to provide a vehicle rear skeleton structure capable of increasing rigidity.

A first aspect of the present disclosure provides a vehicle rear skeleton structure including:
a rear skeleton body portion integrally fabricated by casting and including a wheel house portion and a rear side member portion that extends from a vehicle rear lower portion of the wheel house portion toward a vehicle rear side; and
a reinforcing portion integrally fabricated with the rear skeleton body portion and provided at an upper portion of the rear side member portion on a side of a vehicle rear portion of the wheel house portion.

The vehicle rear skeleton structure according to the first aspect of the present disclosure includes a reinforcing portion provided at an upper portion of the rear side member portion on the side of a vehicle rear portion of the wheel house portion. Therefore, the reinforcing portion can suppress the rise of the rear side member portion at the time of a rear collision. Since the rise of the rear side member portion can be suppressed in this manner, the rise of the wheel house portion can also be suppressed, and thus the rigidity of the entire vehicle rear skeleton structure can be increased.

A second aspect of the present disclosure provides the vehicle rear skeleton structure according to the first aspect, in which
the reinforcing portion connects the vehicle rear portion of the wheel house portion and the upper portion of the rear side member portion.

In the vehicle rear skeleton structure according to the second aspect of the present disclosure, the reinforcing portion connects the vehicle rear portion of the wheel house portion and the upper portion of the rear side member portion. Therefore, at the time of a rear collision, the input load from the rear side member portion can be distributed to the wheel house portion via the reinforcing portion. Accordingly, the rise of the rear side member portion at the time of a rear collision can be suppressed, and thus the rise of the wheel house portion can also be suppressed, and the rigidity of the entire vehicle rear skeleton structure can be increased.

A third aspect of the present disclosure provides the vehicle rear skeleton structure according to the first or second aspect, in which
the reinforcing portion is provided on a shear panel.

In the vehicle rear skeleton structure according to the third aspect of the present disclosure, the reinforcing portion is provided on a shear panel, and thus the rigidity of the shear panel that is a bearing wall can also be increased. Further, at the time of a rear collision, the input load input to the rear side member portion can be distributed to the shear panel by the reinforcing portion.

A fourth aspect of the present disclosure provides the vehicle rear skeleton structure according to any one of the first to third aspects, further including
a strainer portion integrally fabricated with the rear skeleton body portion and extending from an upper portion of the wheel house portion in a vehicle up-down direction toward a vehicle upper side, an upper end of the strainer portion being joined to a roof side rail or a pillar, in which
the reinforcing portion is fabricated continuously from the strainer portion.

In the vehicle rear skeleton structure according to the fourth aspect of the present disclosure, the strength can be increased by integrally forming the rear skeleton body portion and the strainer portion. In addition, when the wheel house portion rises as the side member portion rises, the upper end of the strainer portion is pushed by the roof side rail or the pillar. As a result, the entire wheel house portion is pushed down, suppressing the rise of the wheel house portion. Accordingly, the rigidity of the entire vehicle rear skeleton structure can be increased. Further, the reinforcing portion is formed continuously from the strainer portion, and thus the load can be transmitted smoothly.

As described above, according to the vehicle rear skeleton structure of the present disclosure, the rigidity can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a vehicle rear skeleton structure according to a first embodiment;

FIG. 2 is a perspective view showing details of a main part including a reinforcing portion of the vehicle rear skeleton structure according to the second embodiment;

FIG. 3 is a side view schematically showing a vehicle rear skeleton structure according to a third embodiment; and

FIG. 4 is a perspective view schematically showing a modification of the attachment position of the strainer portion of FIG. 2.

### DETAILED DESCRIPTION OF EMBODIMENTS

### First Embodiment

Hereinafter, a vehicle to which the vehicle rear skeleton structure 10 according to the first embodiment of the present disclosure is applied will be described with reference to the drawings. In the present specification and the drawings, constituent elements having substantially the same functional configuration are denoted by the same reference numerals, and redundant description thereof will be omitted. Further, an arrow FR appropriately shown in the drawings indicates a front side in the vehicle front-rear direction, and an arrow UP indicates an upper side in the vehicle up-down direction. The arrow LH indicates the left side in the vehicle width direction, and the arrow RH indicates the right side in the vehicle width direction, and in the present embodiment, indicates the vehicle width direction outer side. Hereinafter, in the case of simply describing the front-rear direction, the up-down direction, the left-right direction, and the inner-outer direction, unless otherwise specified, it is assumed that the front-rear direction of the vehicle front-rear direction, the up-down direction of the vehicle up-down direction, the left-right direction of the vehicle left-right direction (vehicle width direction), and the inner-outer side of the vehicle width direction are indicated.

Note that, unless otherwise specified in the specification, each element is not limited to one, and a plurality of elements may be present. In addition, in the drawings, substantially the same elements are denoted by the same reference numerals, and redundant description in the specification is omitted.

The vehicle to which the vehicle rear skeleton structure 10 according to the first embodiment is applied includes, for example, a power unit including a motor, an engine, or the like as a drive source, and is a battery electric vehicle and a fuel cell electric vehicle that travel with power generated by the power unit.

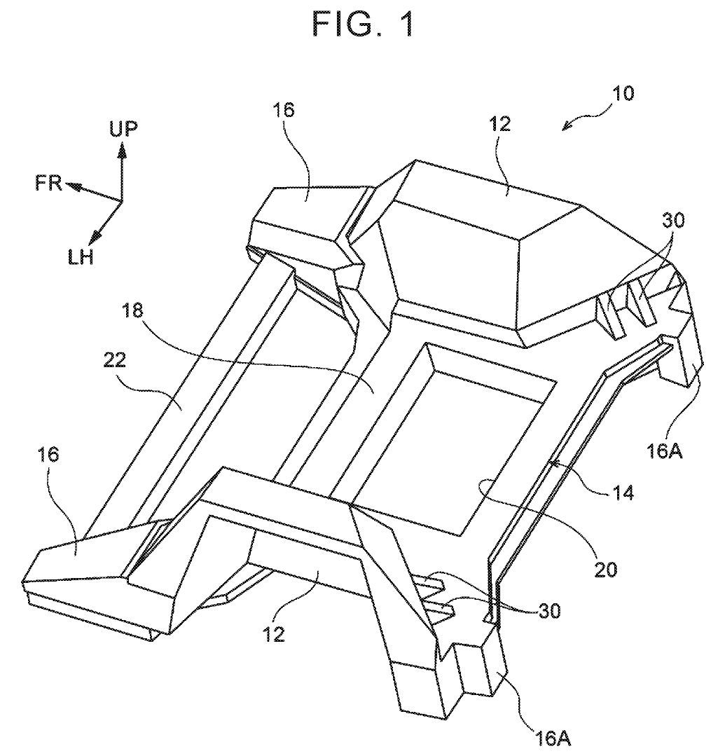

FIG. 1 is a perspective view schematically showing a vehicle rear skeleton structure 10 according to a first embodiment. In FIG. 1, the detailed shape of the vehicle rear skeleton structure 10 is illustrated in a simplified manner as appropriate. The vehicle rear skeleton structure 10 as the skeleton portion of the vehicle shown in FIG. 1 is provided at the rear portion of the vehicle. The vehicle rear skeleton structure 10 is integrally molded by casting.

As shown in FIG. 1, the vehicle rear skeleton structure 10 includes a rear skeleton body portion 11 including a pair of left and right wheel house portions 12, a floor portion 14, and side member portions 16 extending from the pair of left and right wheel house portions 12 to the front and rear of the vehicle. Here, the floor portion 14 is provided between the pair of left and right wheel house portions 12 and serves as a floor portion of the vehicle rear portion. The side member portion 16 extends from the pair of left and right wheel house portions 12 to the front and rear of the vehicle.

The floor portion 14 includes a floor base 18 extending in the vehicle front-rear direction and the vehicle width direction. A wheel house portion 12 is disposed at both left and right end portions of the floor base 18. A substantially rectangular opening portion 20 that penetrates the floor base 18 in the up-down direction is provided at a substantially central portion in the vehicle front-rear direction and the vehicle width direction. A floor panel (not shown) is disposed in the opening.

A pair of left and right side member portions 16 are provided, and each side member portion extends in the front-rear direction from the front end to the rear end of the vehicle rear skeleton structure 10. Further, the front end portion of the side member portion 16 is connected by a connecting portion 22 extending in the vehicle width direction. Therefore, the front portion of the vehicle rear skeleton structure 10 is formed in a substantially frame shape by the floor base 18, the side member portion 16, and the connecting portion 22. The side member portion 16 includes a rear side member portion 16A extending from the wheel house portion 12 toward the rear of the vehicle. A bumper reinforcement (not shown) is attached to a rear end portion of the rear side member portion 16A.

Further, the vehicle rear skeleton structure 10 includes a reinforcing portion 30 provided at an upper portion of the rear side member portion 16A on the vehicle rear portion side of the wheel house portion 12. Specifically, for example, the reinforcing portion 30 connects the rear portion of the wheel house portion 12 to the upper portion of the rear side member portion 16A. More specifically, the reinforcing portion 30 is formed in a substantially triangular shape as viewed from the diagonally forward direction of the vehicle, and is disposed such that a corner portion is positioned at a border portion between the wheel house portion 12 and the rear side member portion 16A. That is, in the reinforcing portion 30, one side other than the oblique side is joined to the upper portion of the wheel house portion 12, and the other side other than the oblique side is joined to the rear surface of the wheel house portion 12. As an example, the vehicle rear skeleton structure 10 of the present embodiment is provided with two reinforcing portions 30 along the rear surface of the wheel house portion 12.

Note that the reinforcing portion 30 of the present embodiment is formed in a substantially triangular shape when viewed from the vehicle obliquely forward direction, but may have other shapes such as a quadrangular shape. Further, in the vehicle rear skeleton structure 10 shown in FIG. 1, the rear surface of the wheel house portion 12 is formed obliquely with respect to the vehicle width direction, but the rear surface may be formed parallel to the vehicle width direction. In this case, the reinforcing portion 30 is arranged to have a substantially triangular shape when viewed in the vehicle width direction. The reinforcing portion 30 is not particularly limited as long as it can connect the vehicle rear portion of the wheel house portion 12 and the upper portion of the rear side member portion 16A.

The vehicle rear skeleton structure 10 configured as described above is integrally molded by casting including a rear skeleton body portion 11, that is, a pair of left and right wheel house portions 12, a floor portion 14 (a floor base 18, an opening portion 20), a side member portion 16, and a connecting portion 22, and two reinforcing portions 30. Here, the side member portion 16 includes a rear side member portion 16A.

### Operations and Effects

Next, the operation and effect of the first embodiment will be described.

In the vehicle rear skeleton structure 10 according to the first embodiment, a reinforcing portion 30 is provided at an upper portion of the rear side member portion 16A on the vehicle rear portion side of the wheel house portion 12. Therefore, it is possible to suppress the rise of the rear side member portion 16A at the time of the rear impact by the reinforcing portion 30. As described above, since the raising of the rear side member portion 16A can be suppressed, the raising of the wheel house portion 12 can also be suppressed, and thus the rigidity of the entire vehicle rear skeleton structure 10 can be increased.

In the vehicle rear skeleton structure 10 according to the first embodiment, the reinforcing portion 30 connects the vehicle rear portion of the wheel house portion 12 and the upper portion of the rear side member portion 16A. Therefore, the input load from the rear side member portion 16A can be distributed to the wheel house portion 12 via the reinforcing portion 30 at the time of the rear collision. Accordingly, it is possible to suppress the rise of the rear side member portion 16A at the time of the rear collision, and thus it is possible to suppress the rise of the wheel house portion 12, and thus it is possible to increase the rigidity of the entire vehicle rear skeleton structure 10.

### Second Embodiment

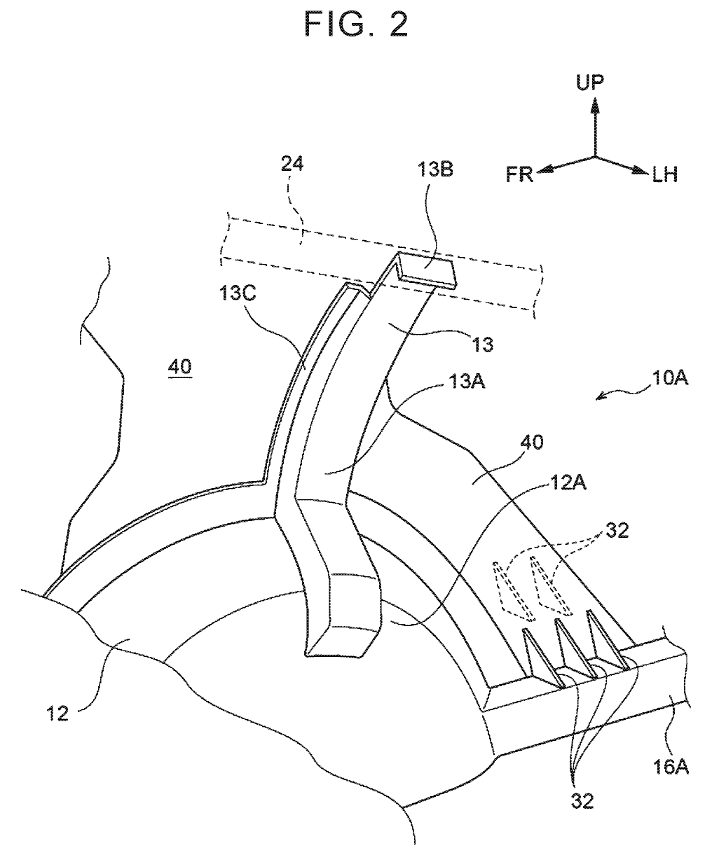

Next, a vehicle rear skeleton structure 10A according to a second embodiment of the present disclosure will be described. In the second embodiment, the same components as those of the vehicle rear skeleton structure 10 of the first embodiment described above are indicated by the same reference numerals, and detailed description thereof will be omitted, and only different components will be described in detail. FIG. 2 is a detailed perspective view of the main part including the reinforcing portion 32 of the vehicle rear skeleton structure 10A according to the second embodiment.

As shown in FIG. 2, the vehicle rear skeleton structure 10A of the second embodiment further includes a strainer portion (also referred to as a brace) 13 on the upper portions of the pair of left and right wheel house portions 12 with respect to the vehicle rear skeleton structure 10 of the first embodiment described above. Strainer portion 13 is extended in the vehicle upward direction along the vehicle widthwise direction inner surface 12A of the wheel house portion 12 as an example. The strainer portion 13 is formed in an open cross-sectional shape having an opening on the outside in the vehicle width direction.

The strainer portion 13 extends upward from an upper portion of the wheel house portion 12. The strainer portion 13 includes a main body portion 13A that is open on the outer side in the vehicle-width direction and extends upward. The main body portion 13A is curved inward in the vehicle-width direction. The main body portion 13A includes, at an upper end thereof, an upper flange portion 13B bent inward in the vehicle-width-direction. The upper flange portion 13B is joined to the roof side rail 24 of the vehicle. The bonding method may be, for example, fastened by a bolt or the like, or a known method can be used.

The main body portion 13A includes a flange portion 13C extending in the vehicle front-rear direction from an outer end portion of the main body portion 13A on both sides in the vehicle front-rear direction. In addition, the flange portion 13C is joined to the shear panel 40 disposed on the vehicle-width-direction outer side of the wheel house portion 12.

The shear panel 40 is disposed on the vehicle width direction outer side of the upper portion of the wheel house portion 12. In the present embodiment, the shear panel 40 functions as a load-bearing wall. In the present embodiment, the shear panel 40 is integrally formed as a whole, but may be formed of a plurality of parts. In addition, the shear panel 40 may be formed integrally with the vehicle rear skeleton structure 10A or may be formed separately.

The vehicle rear skeleton structure 10A of the present embodiment includes a reinforcing portion 32 provided at an upper portion of the rear side member portion 16A on a vehicle rear portion side of the wheel house portion 12. Specifically, for example, the reinforcing portion 32 is provided in the shear panel 40. More specifically, the reinforcing portion 32 connects the upper portion of the rear side member portion 16A to the inner surface of the shear panel 40. In the present embodiment, three reinforcing portions 32 are disposed along the rear side member portion 16A at a distance from each other.

In the present embodiment, the vehicle rear skeleton structure 10A includes three reinforcing portions 32, but the present disclosure is not limited thereto. The number of the reinforcing portions 32 may be one or three or more. Further, the shape of the reinforcing portion 32 is not limited to a substantially triangular shape, and may be a substantially quadrangular shape or may be appropriately changed. Further, the reinforcing portion 32 may be provided at the upper portion of the rear side member portion 16A on the vehicle rear portion side of the wheel house portion 12, and may not be strictly connected to the upper portion of the rear side member portion 16A. That is, the reinforcing portion 32 may be disposed at a position indicated by a dotted line in FIG. 2. The installation position of the reinforcing portion 32 can be appropriately changed in accordance with the peripheral shapes of the wheel house portion 12, the shear panel 40, and the like.

The vehicle rear skeleton structure 10A configured as described above is integrally molded by casting including a rear skeleton body portion 11, that is, a pair of left and right wheel house portions 12, a floor portion 14 (a floor base 18, an opening portion 20), a side member portion 16, and a connecting portion 22, a strainer portion 13, and three reinforcing portions 32.

### Operations and Effects

Next, the operation and effect of the second embodiment will be described.

In the vehicle rear skeleton structure 10A according to the second embodiment, since the reinforcing portion 32 is provided in the shear panel 40, the stiffness of the shear panel 40, which is a bearing wall, can also be increased. Further, at the time of the rear collision, the input load to be input to the rear side member portion 16A can be distributed to the shear panel 40 by the reinforcing portion 32.

Further, in the vehicle rear skeleton structure 10A according to the second embodiment, the strength can be increased by integrally forming the rear skeleton body portion 11 and the strainer portion 13. Further, when the rear side member portion 16A rises at the time of the rear collision, when the wheel house portion 12 rises, the upper end of the strainer portion 13 is pushed by the roof side rail 24. As a result, the entire wheel house portion 12 is pushed down, so that the raising of the wheel house portion 12 can be suppressed. Accordingly, the rigidity of the entire vehicle rear skeleton structure 10A can be increased.

### Third Embodiment

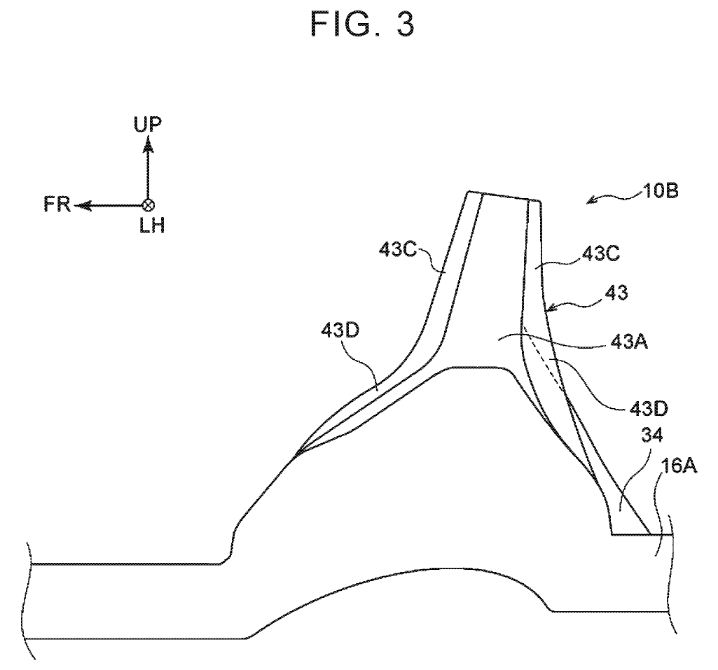

Next, a vehicle rear skeleton structure 10B according to a third embodiment of the present disclosure will be described. Note that, in the third embodiment, the same components as those of the vehicle rear skeleton structure 10A of the second embodiment described above are denoted by the same reference numerals, and detailed descriptions thereof are omitted, and only differing components will be described in detail. FIG. 3 is a side view schematically showing a vehicle rear skeleton structure 10B according to a third embodiment.

As shown in FIG. 3, both end portions of the strainer portion 43 in the vehicle front-rear direction extend continuously from both end portions of the wheel house portion 12 in the vehicle front-rear direction in the strainer portion 43 of the vehicle rear skeleton structure 10B of the third embodiment. Specifically, as shown in FIG. 3, the strainer portion 43 includes a main body portion 43A that is open on the outer side in the vehicle-width direction and extends upward from the upper portion of the wheel house portion 12.

The main body portion 43A is curved inward in the vehicle-width direction. The main body portion 43A includes a lower flange portion 43C extending in the vehicle front-rear direction from an outer end portion of the main body portion 43A on both sides in the vehicle front-rear direction. The lower flange portion 43C extends below the lower end of the main body portion 43A, and the extended portion 43D is joined to the wheel house portion 12. The extended portion 43D is narrower toward the lower side, and extends to a height in the vicinity of the rear side member portion 16A.

Further, the vehicle rear skeleton structure 10B of the third embodiment includes a reinforcing portion 34 provided at an upper portion of the rear side member portion 16A on the vehicle rear portion side of the wheel house portion 12. Specifically, for example, the reinforcing portion 34 is formed continuously from the strainer portion 43. That is, the reinforcing portion 34 connects the upper portion of the rear side member portion 16A to the strainer portion 43.

In the present embodiment, the upper end (one end) of the reinforcing portion 34 is connected to the main body portion 43A of the strainer portion 43, and the lower end (the other end) thereof is connected to the upper surface of the strainer portion 43. In the vehicle rear skeleton structure 10B of the present embodiment, one reinforcing portion 34 is provided, but a plurality of reinforcing portions 34 may be provided with a gap in the vehicle widthwise direction.

In the present embodiment, the shape of the reinforcing portion 34 is not particularly limited, and may be a substantially triangular shape or a substantially quadrangular shape in a side view, or may be appropriately changed. Further, in the present embodiment, the reinforcing portion 34 is continuously formed up to the center portion in the up-down direction of the strainer portion 43, but may be continuously formed up to the upper end of the strainer portion 43.

The vehicle rear skeleton structure 10B configured as described above is integrally molded by casting including a rear skeleton body portion 11, that is, a pair of left and right wheel house portions 12, a floor portion 14 (a floor base 18, an opening portion 20), a side member portion 16, and a connecting portion 22, a strainer portion 43, and a reinforcing portion 34.

### Operations and Effects

Next, the operation and effect of the third embodiment will be described.

In the vehicle rear skeleton structure 10B according to the third embodiment, the strength can be increased by integrally forming the rear skeleton body portion 11 and the strainer portion 43. Further, when the rear side member portion 16A rises at the time of the rear collision, when the wheel house portion 12 rises, the upper end of the strainer portion 43 is pushed by the roof side rail 24. As a result, the entire wheel house portion 12 is pushed down, so that the raising of the wheel house portion 12 can be suppressed. Accordingly, the rigidity of the entire vehicle rear skeleton structure 10B can be increased.

In the vehicle rear skeleton structure 10B according to the third embodiment, both end portions of the strainer portion 43 in the vehicle front-rear direction extend continuously from both end portions of the wheel house portion 12 in the vehicle front-rear direction. Therefore, the load can be smoothly transmitted between the strainer portion 43 and the wheel house portion 12.

In the vehicle rear skeleton structure 10B according to the third embodiment, the reinforcing portion 34 is formed continuously from the strainer portion 43. Therefore, the input load to be input to the rear side member portion 16A at the time of the rear collision can be distributed to the strainer portion 43 by the reinforcing portion 34.

### Supplementary Explanation

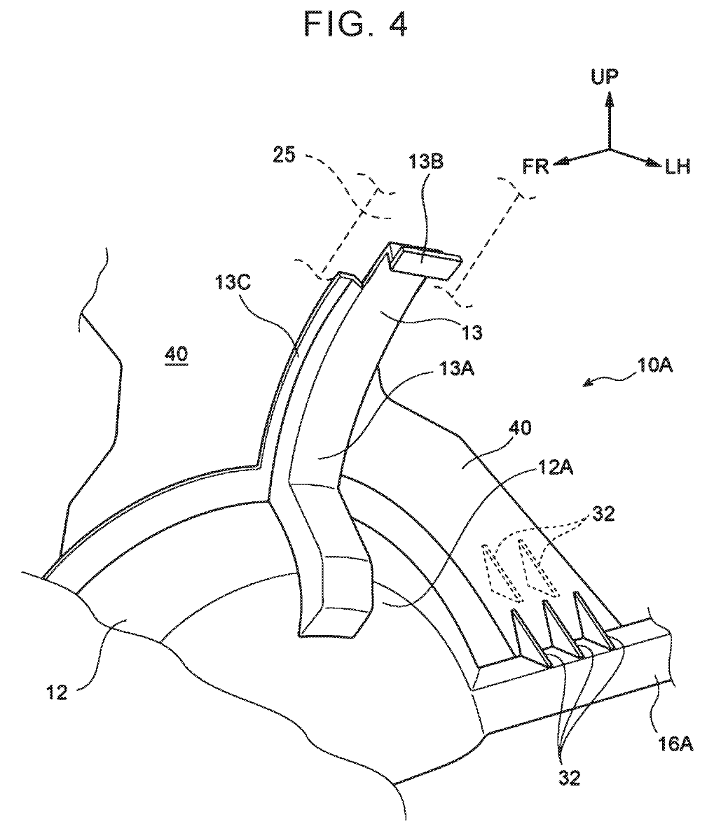

In the above-described embodiment, the upper end of the strainer portion is joined to the roof side rail 24, but the present disclosure is not limited thereto. For example, as shown in FIG. 4, it may be joined to the rear pillar 25.

Further, the configuration of the present disclosure is not limited to the above-described embodiment, and the configuration can be changed as appropriate as long as the problem can be solved.

What is claimed is:

1. A vehicle rear skeleton structure comprising:
a rear skeleton body portion integrally fabricated by casting and including a wheel house portion and a rear side member portion that extends from a vehicle rear lower portion of the wheel house portion toward a vehicle rear side; and
a reinforcing portion integrally fabricated with the rear skeleton body portion and provided at an upper portion of the rear side member portion on a side of a vehicle rear portion of the wheel house portion.

2. The vehicle rear skeleton structure according to claim 1, wherein the reinforcing portion connects the vehicle rear portion of the wheel house portion and the upper portion of the rear side member portion.

3. The vehicle rear skeleton structure according to claim 1, wherein the reinforcing portion is provided on a shear panel.

4. The vehicle rear skeleton structure according to claim 1, further comprising
a strainer portion integrally fabricated with the rear skeleton body portion and extending from an upper portion of the wheel house portion in a vehicle up-down direction toward a vehicle upper side, an upper end of the strainer portion being joined to a roof side rail or a pillar, wherein
the reinforcing portion is fabricated continuously from the strainer portion.
